(19) United States
(12) Patent Application Publication
(10) Pub. No.: US 2011/0285387 A1
(43) Pub. Date: Nov. 24, 2011

(54) ROTOR WITH A COMPENSATING MASS FOR A RELUCTANCE RESOLVER, AND RELUCTANCE RESOLVER

(75) Inventors: Wulf Andrae, Speyer (DE); Stefan Laux, Stutensee (DE); Markus Colloseus, Speyer (DE)

(73) Assignee: Tyco Electronics AMP GmbH, Bensheim (DE)

(21) Appl. No.: 13/124,116

(22) PCT Filed: Oct. 12, 2009
(86) PCT No.: PCT/EP2009/063271

§ 371 Date: Apr. 13, 2011

(30) Foreign Application Priority Data
Oct. 13, 2008 (DE) 10 2008 051 524.8

(51) Int. Cl. G01B 7/30

(52) U.S. Cl. 324/207.25

(57) ABSTRACT

The invention relates to a rotor (1) with a signal transmitter mass (3), which is distributed non-uniformly in the circumferential direction (U), for a reluctance resolver (16) and also to a reluctance resolver (16) for converting a rotational value into an electrical signal based on a change of a magnetic field. In order to minimise an unbalance, generated as a result of the non-uniformly distributed signal transmitter mass (3) during operation, and wear phenomena resulting therefrom, the invention provides for the rotor (1) to have at least one non-magnetic compensating mass (4) compensating for the distribution of the total mass (2) of the rotor (1).

The invention relates to a rotor which is designed so as to be able to be rotationally engaged with a shaft and to be able to be combined with a stator so as to form a reluctance resolver converting a rotational value into an electrical signal, the rotor being designed in such a way that the axis of rotation of the shaft and the longitudinal axis of the rotor coincide in the connected state and the rotor has at least one signal transmitter mass which is distributed non-uniformly in the circumferential direction.

Furthermore, the invention relates to a reluctance resolver for converting a rotational value of a shaft, such as an angular position or an angular acceleration, into an electrical signal, with a stator comprising at least one magnetic field generator which in operation generates a magnetic field and at least one magnetic field sensor which converts the magnetic field into an electrical signal, and with a rotor which is arranged in the interior of the stator and comprises a signal transmitter mass which can be used to change the magnetic field in the region of the magnetic field sensor as a function of the rotational value.

Rotors for reluctance resolvers and reluctance resolvers for converting a rotational value are known in the art and are used to determine rotational values by means of a modulation of a magnetic field and subsequent conversion of the modulated magnetic field into an electrical signal. For this purpose, reluctance resolvers have at least one magnetic field generator generating the magnetic field and at least one magnetic field sensor transforming the magnetic field into an electrical signal. The magnetic field which is transformed by the at least one magnetic field sensor into the signal is altered based on a signal transmitter mass introduced into the magnetic field. Thus, for example, the flux density of the magnetic field in the region of the magnetic sensor depends on the position of the signal transmitter mass in the magnetic field.

The signal transmitter mass is for this purpose designed, for example, with a metal having high permeability and low remanence. For determining the rotational value, the signal transmitter mass, in the form of the rotor, is rotationally engaged with a shaft having the rotational value. If a rotational value, for example an angular velocity, is applied to the shaft, then the rotor rotates in the magnetic field.

DE 31 41 015 A1 discloses rotors with a circular base. In order then to influence the magnetic field, a circular cylindrically shaped rotor can be connected to the shaft in such a way that its longitudinal axis or else its axis of symmetry is arranged parallel to and offset from the rotational axis of the shaft. The rotor rotates not about its longitudinal axis but about the axis of rotation, which is arranged offset from the longitudinal axis, so that the mass centre of gravity of the rotor moves through the magnetic field. The rotor performs wobbling, reciprocating movements.

If the rotor is to move more uniformly through the magnetic field and not perform, for example, any reciprocating wobbling movements, its longitudinal axis can also be aligned with the axis of rotation. However, in order for the magnetic field to be influenced by the movement of the rotor, DE 31 41 015 A1 discloses that the distribution of the signal transmitter mass is non-uniform in the circumferential direction of the rotor. For example, the rotor can have more mass on one side of its longitudinal axis than on another axis and be embodied as an obliquely cut circular cylinder.

The above-described rotor designs allow the rotational value to be converted, using the reluctance resolver, into an electrical signal which can display the rotational value. However, in order to be able to display also the amount of the rotational value, it is necessary to provide at least two magnetic field sensors which are to be provided around the rotor, offset about the axis of rotation for example by 90°.

If the rotor is embodied as an obliquely cut circular cylinder or non-centrically connected to the shaft, then there is produced during operation an unbalance which can lead, specifically in the case of rotational values having high angular velocities or angular accelerations, to mechanical loads and finally to rapid wear of the reluctance resolver.

It is therefore the object of the present invention to provide a rotor for a reluctance resolver or a reluctance resolver which can be operated with low mechanical wear phenomena even at high rotational speeds.

For the rotor mentioned at the outset, the object is achieved in that the rotor has at least one non-magnetic compensating mass compensating for the non-uniform distribution of the signal transmitter mass.

The solution according to the invention is simple in terms of design and has the advantage that the magnetic field applied to the magnetic sensor can be changed, as the result of the non-uniform spatial distribution of the signal transmitter mass, as a function of the rotational value when the signal transmitter mass rotates about the longitudinal axis of the rotor, which coincides with the axis of rotation of the shaft in the assembled state, or is in an angular position to be determined. An unbalance, which increases the wear and is caused by the non-uniform distribution of the rotating signal transmitter mass, is in this case at least alleviated by the compensating mass, allowing the service life of the reluctance resolver to be extended. The distribution of the compensating mass can in this case be provided in such a way that the non-uniform distribution of the signal transmitter mass is compensated for and the total mass of the rotor, which is formed substantially from the signal transmitter mass and the compensating mass, is distributed identically or, in particular, symmetrically about its longitudinal axis. The rotor can therefore be embodied, for example, as a rotational body which can rotate, without significant unbalance forces pointing away from the axis of rotation, about the axis of rotation of the shaft, which coincides with its longitudinal axis or axis of symmetry.

The solution according to the invention may be further improved by various embodiments which are each per se advantageous and may be combined with one another as desired. These designs and the advantages associated therewith will be examined hereinafter.

Thus, the rotor can be balanced as a result of the interacting of the signal transmitter mass and the non-magnetic compensating mass. A balanced rotor, which has a mass distributed symmetrically about its longitudinal axis and rotates about its longitudinal axis leading through its centre of gravity, can transfer the rotational value from the shaft to the reluctance resolver without thereby generating vibrations causing excessive wear.

In order to be able to modulate the magnetic field as effectively as possible, the non-uniformly distributed signal transmitter mass can be made of a substantially soft magnetic material and the compensating mass can be made of a substantially non-magnetic material which influences the magnetic field at most insubstantially. For example, magnetic and non-magnetic ceramics can be used in this case. However, metals are generally simpler and more economical to manufacture, so that the signal transmitter mass can be made of a soft magnetic metal, for example of a suitable nickel-iron alloy, and the compensating mass can be made of a substantially non-magnetic metal, for example of a suitable high-grade steel. Although, for example, the signal transmitter mass can also be made of a ceramic and the compensating mass be made of a metal, ceramic-ceramic and metal-metal pairings are more advantageous for the magnetic mass and the compensating mass if the reluctance resolver is to be operated over a broad temperature range of from, for example, −40° C. to +70° C., as the differences in the thermal expansion of similar materials are generally low, allowing mechanical stresses and, if possible, damage resulting therefrom to be avoided.

It is particularly advantageous if the signal transmitter mass and the compensating mass are joined together, forming the rotor, via a plane which is inclined in relation to the longitudinal axis of the rotor, as in this way the magnetic field is sinusoidally changeable. In this case, the surface of the signal transmitter mass that points away from the compensating mass can have, in an unwound view, a sinusoidal contour, thus promoting the sinusoidal shape of the generated signal.

The amplitude of the sinusoidal signal is in this case inversely proportionally related to the angle at which the plane is inclined to the longitudinal axis. Depending on the design of the rotor, the connecting face can be a connecting plane extending at an acute angle to the longitudinal axis. In particular, the connecting plane can extend diagonally through the rotor.

The signal transmitter mass and the compensating mass can, for example, be adhesively connected to each other via their connecting face. However, on account of thermal, mechanical or chemical environmental conditions, it may be advantageous if the signal transmitter mass and the compensating mass are fastened to each other with a material-to-material fit, i.e. for example welded, or mechanically and, for example, pinned together, use being made of at least two symmetrically arranged connecting regions, in this case for example connecting pins provided in connecting sockets of the signal transmitter mass and the compensating mass.

Particularly advantageous for many fields of application is a rotor with a circular cylindrical surface, the signal transmitter mass and the compensating mass supplementing each other to form the rotor and the axis of symmetry of the circular cylindrical surface of the rotor coinciding with the longitudinal axis thereof. In this case, the signal transmitter mass and the compensating mass can have a substantially identical specific density and be shaped symmetrically with a predominantly identical volume and complementary form, so that the total mass of the rotor is distributed symmetrically about its longitudinal axis.

A circular cylinder, which rotates about its axis of symmetry coinciding with its longitudinal axis, assumes, irrespective of the rotational value, a stable position in space. No bulge, protruding from the surface of the rotor, forms a collision region for other components of the reluctance resolver. Furthermore, a rotor designed in this way offers the advantage that an impeller effect caused by the rotating rotor is negligibly low. Therefore, the rotor according to the invention can be used also in fluids, such as for example liquids, without the liquids being intensively moved by the rotor and without the risk of the mass of the liquid impairing the measurement.

Thus, a reluctance resolver for converting the rotational value of the shaft, such as an angular position or an angular acceleration, into an electrical signal, with a stator comprising at least one magnetic field generator which in operation generates a magnetic field and at least one magnetic field sensor which converts the magnetic field into an electrical signal, can be used even at high rotational values or when filled with liquids if there is provided in the interior of the stator a rotor according to the invention which can be used to change the magnetic field in the region of the magnetic field sensor as a function of the rotational value.

The magnetic generator can be designed as a primary coil through which an alternating current flows. The alternating current can be designed sinusoidally and have, for example, a frequency of from 2 to 10 kHz. The at least one magnetic field sensor can be embodied as a secondary coil. If a second magnetic field sensor, which can be designed as a second secondary coil, is provided and arranged so as to be offset about the longitudinal axis by an angle of, for example, 90° to the first magnetic field sensor, the sign of the rotational value can also be derived from the signals generated by the two magnetic field sensors. The second magnetic field sensor is also necessary in order to be able to unambiguously determine the rotational value, for example the angular position, over 360°.

In particular if the rotor has a circular cylindrical surface and is inserted into the stator, an annular gap can remain between the rotor and the stator in the radial direction along the longitudinal axis. The annular gap can have a constant minimum thickness in the circumferential direction, so that the rotor and the stator are at a constant minimum distance from each other along the longitudinal axis in the circumferential direction. If the stator is therefore designed so as to be hollow cylindrical, at least in certain portions, with inner, circular cylindrically arranged surface portions and if the axes of symmetry of the stator and the rotor are aligned with each other, then the distance between the surface portions of the stator and the rotor is constant and can be embodied so as to be very low and, for example, less than 1 mm. In the case of a decreasing distance, the modulation rate of the magnetic field, and thus also the amplitude of the electrical signal, rises. Furthermore, the precision with which the rotational value can be determined increases.

As mentioned hereinbefore, the circular cylindrical rotor interacts only slightly with fluids present in the reluctance resolver. However, should these fluids impair the functioning of the reluctance resolver and in particular the functioning of the electrically operated stator, then the volume arranged around the, in this case purely mechanical, rotor can be separated from the stator. For this purpose, a separating element, which can be designed as a foil separating the stator from the rotor in a fluid-tight manner or a thin metal sheet, can be arranged in the annular gap. Should the fluid be corrosive, the foil can be made of a non-corroding material. A material of this type may be, for example, a high-grade steel which allows the magnetic field to pass through it, if possible without resistance, in order to influence the measurement of the rotational value as little as possible. In this case too, a suitable and in particular non-magnetic high-grade steel may be used.

In particular if the fluid is corrosive and may even be under a high pressure, it may be advantageous if the rotor is cut off from the rotor, thus preventing the fluid from passing from the volume around the rotor to the stator. For this purpose, the separating element can be designed in a cap-shaped manner and, placed over the cylindrical rotor, be connected to the stator in a pressure-tight manner. In this case, the rotor and the separating element can be arranged set apart from each other and without contact, so that the surface of the rotor does not rest against or grind against the separating element.

If the reluctance resolver is used, for example, to determine a rotational value of a motor shaft of a hydraulic pump, then pressurised hydraulic oil can enter the volume around the rotor via the motor shaft at least during operation. However, the separating element can be used to prevent the hydraulic oil from transferring to the stator, even if the pressure of the hydraulic oil is more than 110 bar. The separating element can be supported on the surface of the stator, which surface can be formed by the hollow cylindrical surface portions, counter to the pressure exerted by the hydraulic oil, so that in particular the shaping of the separating element can remain substantially unimpaired.

The separating element can be made, for example, of a fine metal sheet having a thickness of between 1 mm and 0.01 mm. As the thickness of the metal sheet increases, the separating element becomes more stable. However, the metal sheet takes up space because the metal sheet must not enter into contact with the rotor, which may rotate rapidly, and thus the annular gap must be made larger in the radial direction in the case of thicker metal sheets. However, as described above, the precision and the signal amplitude deteriorate as the annular gap becomes thicker. A metal sheet having a thickness of 0.2 mm has proven particularly advantageous for applying the reluctance resolver with a hydraulic pump, wherein pressurised hydraulic oil can enter the volume around the rotor.

In order to reduce eddy currents, the circular cylindrical surface of the rotor can be slotted substantially parallel to the longitudinal direction of the rotor. The slots can have a radially extending depth of about 1 mm and a width, pointing in the circumferential direction, of 0.2 mm.

Furthermore, the rotor can have symmetrically arranged pairs of signal transmitter masses and compensating masses which are each embodied with an identical specific density and an identical volume and can alternate, in particular, around the circumference of the rotor. Compared to the prior exemplary embodiments, in which the electrical signal has, for each 360° revolution, in each case just one period of a sinusoidal signal, the signal can have in this case one period for each pair of masses.

The invention will be described hereinafter by way of example based on embodiments with reference to the drawings. The different features of the embodiments may be combined in this case independently of one another, as was previously stated in the individual advantageous designs.

In the drawings:

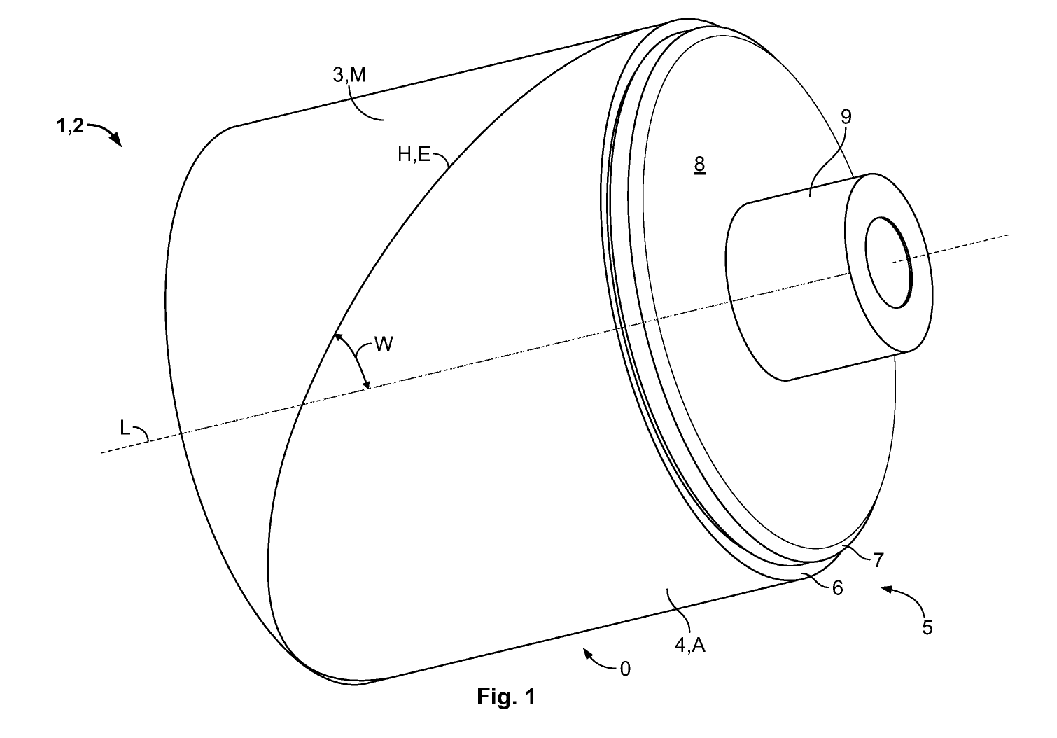

FIG. 1 is a perspective view of a rotor according to the invention;

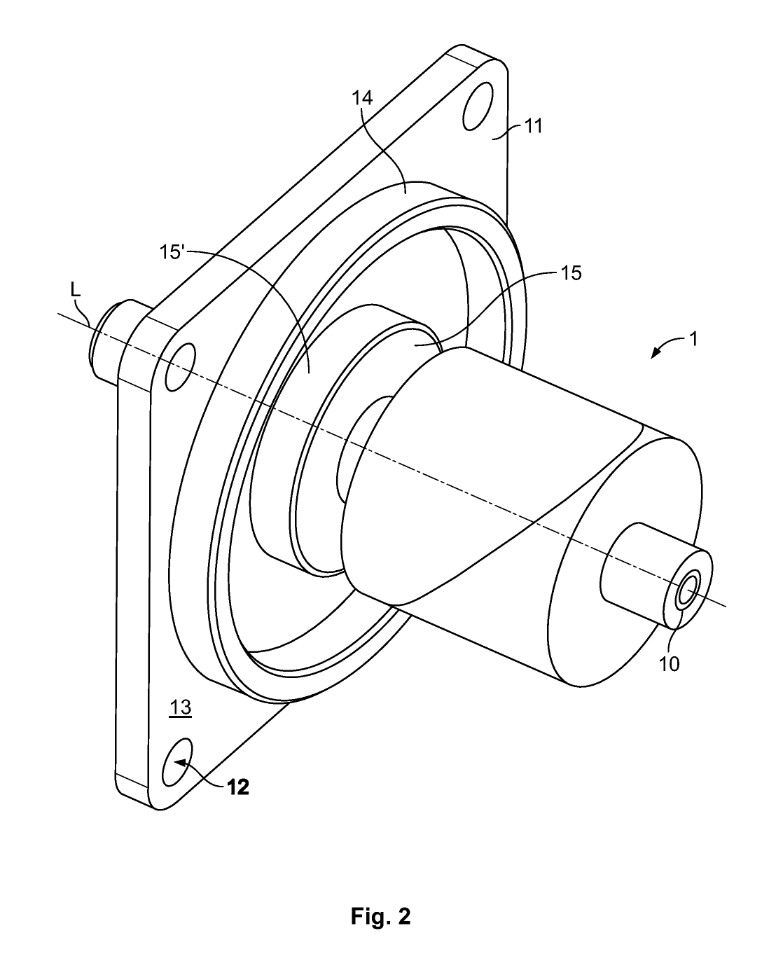

FIG. 2 is a perspective view of an exemplary embodiment of the invention in which the rotor is connected to a holding plate;

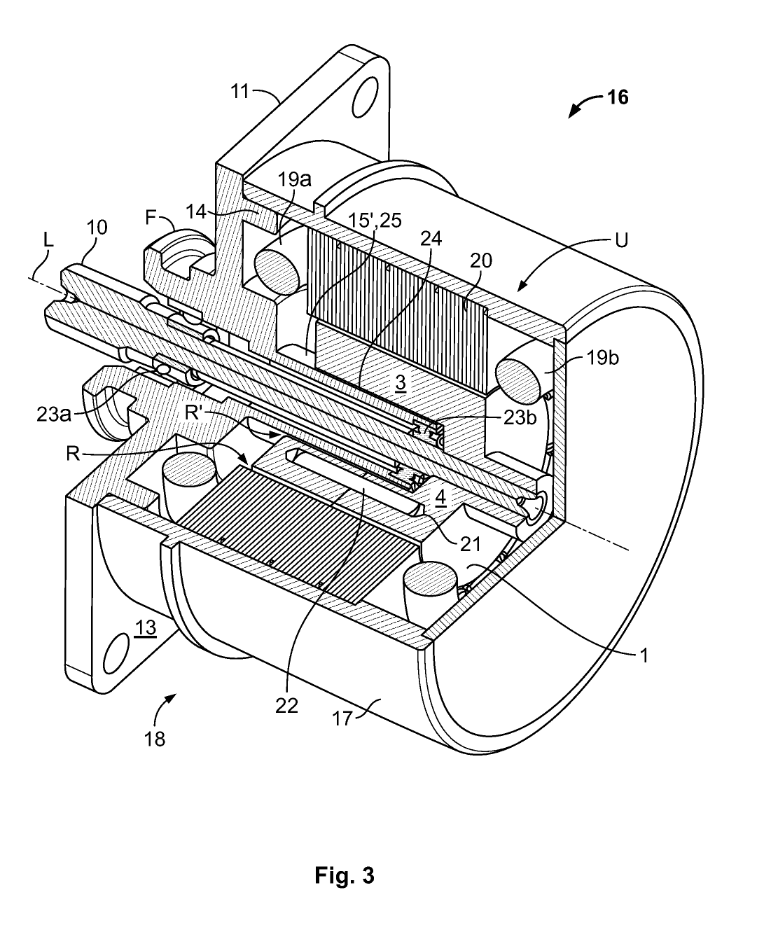

FIG. 3 is a perspective sectional view of the reluctance resolver according to the invention; and

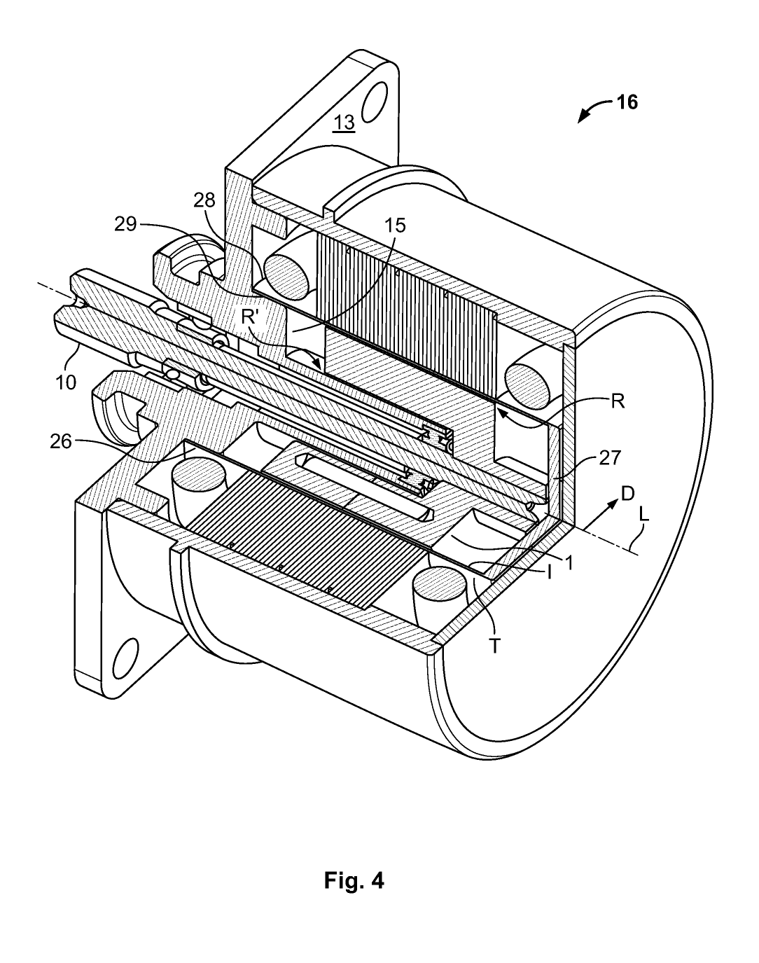

FIG. 4 is a perspective sectional view of a further exemplary embodiment of the reluctance resolver.

The construction and functioning of a rotor 1 will first be described with reference to the exemplary embodiment of FIG. 1. The rotor 1 comprises a total mass 2 shown in this case substantially with a circular cylindrical surface O. The circular cylindrical surface O is designed rotationally symmetrically about a longitudinal axis L of the rotor 1. The total mass 2 comprises in this case two partial masses 3, 4. The partial mass 3 is designed as a signal transmitter mass 3 having high permeability and low remanence. In particular, the signal transmitter mass 3 can be made substantially of a soft magnetic material. The signal transmitter mass 3 is shown in this case designed, at least in certain portions, with a circular cylindrical surface M. However, the circular cylindrical shape is cut by a plane E illustrated here as a line. Along the plane E the signal transmitter mass 3 forms a connecting face H which extends inclined at an angle W relative to the longitudinal axis L.

It may be seen that in this view the signal transmitter mass 3 is distributed non-uniformly about the longitudinal axis L. In FIG. 1 the signal transmitter mass 3 has a larger volume above the longitudinal axis L than below the longitudinal axis L. As a result, the signal transmitter mass 3 has a greater mass above the longitudinal axis L than below the longitudinal axis L. If the signal transmitter mass 3 now rotates about the longitudinal axis L, an unbalance is produced.

In order to balance the rotor 1, the rotor is shown here with the partial mass 4 which is designed as a compensating mass 4. The compensating mass 4 supplements the signal transmitter mass 3 to form the total mass 2 of the rotor 1 and is also shown embodied, at least in certain portions, with a circular cylindrical surface A. The compensating mass 4 is also embodied so as to be cut along the plane E at an angle W to the longitudinal axis L and substantially complementary to the signal transmitter mass 3. The angle W is, in the exemplary embodiment shown here, an acute angle.

In contrast to the signal transmitter mass 3, the compensating mass 4 is made of a substantially non-magnetic material which influences a magnetic field at most insubstantially. In particular, the signal transmitter mass 3 and the compensating mass 4 have substantially the same specific density, so that the two partial masses 3, 4 jointly allow a balanced total mass 2 of the rotor 1.

The compensating mass 4 is shown, at its free end region 5 pointing away from the signal transmitter mass 3, with a step 6 tapering the rotor 1 and a chamfer 7 further tapering the rotor 1. A hollow cylindrical receptacle 9, which can be shaped for example together with the compensating mass 4, for a shaft (not shown here) is arranged centrally on a substantially flat closing face 8 of the compensating mass 4, the closing face extending perpendicularly to the longitudinal axis L and pointing away from the signal transmitter mass 3. This shaft may be a motor shaft, for example a hydraulic pump, or be embodied as an adapter piece for connecting the rotor 1 to the motor shaft.

Alternatively, the compensating mass 4 can also be made of a magnetic material and the signal transmitter mass 3 of a non-magnetic material.

If the surface M of the signal transmitter mass 3 is shown in an unwinder, then the edge thereof extending along the plane E has a substantially sinusoidally contoured course.

FIG. 2 shows a second exemplary embodiment, the same reference numerals being used for elements which correspond in function and construction to the elements of the exemplary embodiment of FIG. 1. For the sake of brevity, merely the differences from the exemplary embodiment of FIG. 1 will be examined.

FIG. 2 shows the rotor 1 which is rotationally engaged with a holding plate 11 via a shaft 10. The holding element 11 is designed so as to be substantially flat and square and has fastening openings 12 which are arranged in its corners and via which the holding plate 11 can be screwed, for example, to the housing of a motor. The holding plate 11 has two concentrically embodied elements 14, 15 on its side 13 facing the rotor 1. The outer concentric element 14 is designed as a collar 14 extending substantially perpendicularly from the holding plate 11 toward the rotor 1.

In a central region of the collar 14 the inner concentric element 15 is embodied as a rotary feedthrough 15, through the centre of which the shaft 10 is guided. The rotor 1 is rotationally engaged with the holding plate 11 via the shaft 10. An outer side face 15′, pointing away from the longitudinal axis L in the radial direction D, of a shoulder region of the rotary feedthrough 15 is embodied so as to be circular cylindrical and symmetrical about the longitudinal axis L, the diameter of the side face 15′ being at least slightly larger than the diameter of the circular cylindrical rotor 1.

FIG. 3 shows an exemplary embodiment of a reluctance resolver according to the invention, the same reference numerals being used for elements which correspond in function and construction to the elements of the exemplary embodiments of FIG. 1 or 2. For the sake of brevity, merely the differences from the exemplary embodiment of FIG. 1 or 2 will be examined.

FIG. 3 shows a reluctance resolver 16 which is illustrated with a cut-out square. The reluctance resolver 16 is shown with the holding plate 11 which is connected to the rotor 1 via a shaft 10. A housing shell 17, which is embodied in a substantially circular cylindrical or else pot-shaped manner, is attached to the side 13 of the holding plate 11 that points toward the rotor 1. The housing shell 17 comprises the collar 14, to the outer face, pointing radially away from the longitudinal axis, of which the housing shell can for example be screwed, welded or otherwise securely connected. The housing shell 17 is embodied in a hollow cylindrical manner, a stator arrangement 18 being arranged on the inner side thereof.

The stator 18 comprises at least one coil with two winding heads 19a, b and also a laminated stator core 20 which jointly form the substantially tubular stator 18 extending symmetrically about the longitudinal axis L. The coil can comprise at least one primary coil and also at least one secondary coil, the primary coil being configured as a magnetic field generator generating a magnetic field and the at least one secondary coil being configured as a magnetic field sensor converting the magnetic field into an electrical signal. In this case, the influence of the signal transmitter mass 3 on the magnetic field, which is perceived through the magnetic field sensor and converted during operation into the signal, differs depending on the position of the rotor 1.

The signal transmitter mass 3 and the compensating mass 4 have in their interior openings 21 which are aligned with one another, extend parallel to the longitudinal axis L and can be shaped, for example, as a bore. An alignment pin 22, via which the signal transmitter mass 3 and the compensating mass 4 are securely connected to each other, is inserted into the opening 21. The openings 21 are distributed symmetrically about the longitudinal axis L.

The shaft 10 is held in the rotary feedthrough 15 so as to be able to rotate about the longitudinal axis L of the rotor 1 via at least two bearings 23a, b. The bearing 23b is arranged in the region of the free end region 5 of the compensating mass 4 into which a hollow cylindrical extension of the rotary feedthrough 15 extends. The rotary feedthrough 15 is shown received, at least in part, by the, in this case hollow cylindrically shaped, rotor 1, at least the region of the rotary feedthrough 15 that is surrounded by the rotor 1 being shaped in a circular cylindrical manner, so that an inner annular gap R′ remains between the inside 24 of the rotor 1 and the outside 25 of the rotary feedthrough 15. The second guide 23a is arranged, on the side of the holding plate 11 that is remote from the rotor 1, in a flange F which is connected to the holding plate 11. The rotor 1 is therefore shown connected to the rotary feedthrough 15 not directly, but via the shaft 10.

The longitudinal axis L of the rotor 1 is aligned with the axis of rotation of the shaft 10, so that an outer annular gap R, which extends along the longitudinal axis L, remains between the circular cylindrical surface O of the rotor 1 and the substantially hollow cylindrically shaped stator 18. The outer annular gap R has in the circumferential direction U a substantially constant radial minimum thickness.

FIG. 4 shows a further exemplary embodiment of the reluctance resolver according to the invention, the same reference numerals being used for elements which correspond in function and construction to the elements of the exemplary embodiments of the foregoing figures. For the sake of brevity, merely the differences from the exemplary embodiments of the figures described hereinbefore will be examined.

FIG. 4 shows the reluctance resolver 16 with the rotor 1. A cap-shaped separating element 26 is placed over the rotor 1 and arranged in the outer annular gap R. The cap-shaped separating element 26 consists of a thin metal sheet or a foil made of a non-magnetic high-grade steel, for example 1.4404, and has, like a cup, a closed bottom 27 and an opening 28 opposing the bottom 27. A side wall of the separating element 26, the side wall extending between the bottom 27 and the opening 28, is tubular or hollow cylindrical in its embodiment. The inside I of the side wall that points toward the longitudinal axis is set apart from the rotor 1; the outside U, which points away from the longitudinal axis L, is shown resting, at least in part, against the stator core 20 which is designed with circular cylindrically arranged surface portions pointing to the rotor 1.

The separating element 26 is arranged in the reluctance resolver 16 with the bottom 27 directed away from the side 13 of the holding plate 11 and with the opening 28 slid over the outer side face 15′ of the rotary feedthrough 15. The outer side face 15′ of the rotary feedthrough 15 is shaped with a connecting portion 29 pointing away from the longitudinal axis L in the radial direction D. In the region of the connecting portion 29 the separating element 26 is connected to the rotary feedthrough 15 in such a way that a volume surrounding the rotor 1 is separated off from the stator 18 in a fluid-tight manner. For example, the separating element 26 can be laser-welded or else connected otherwise in a fluid and pressure-tight manner to the connecting portion 29.

If the shaft 10 is for example connected to a motor shaft of a hydraulic pump, then hydraulic oil can infiltrate the reluctance resolver 16 via edge regions of the shaft 10. Generally, hydraulic oil is under a high pressure of, for example, up to 110 bar or else more and can have a corrosive effect on many materials. If the hydraulic oil now enters the reluctance resolver 16 along the shaft 10, then the volume around the rotor 1 is first filled. However, the rotor 1 is designed so as to be insensitive to the hydraulic oil or the corrosive properties thereof. The cap-shaped separating element 26, which is also insensitive to the corrosive properties of the hydraulic oil, prevents the hydraulic oil from spreading beyond the volume arranged around the rotor 1. For this purpose, the separating element 26, and the connection thereof to the connecting portion 29 of the rotary feedthrough 15, is, in particular, designed so as to be fluid-tight and able to withstand even high pressures.

1-13. (canceled)

14. Rotor which is designed so as to be able to be rotationally engaged with a shaft and to be able to be combined with a stator so as to form a reluctance resolver converting a rotational value into an electrical signal, the rotor being designed in such a way that the axis of rotation of the shaft and the longitudinal axis of the rotor coincide in the connected state and the rotor has at least one signal transmitter mass which is distributed non-uniformly in the circumferential direction, wherein the rotor has at least one non-magnetic compensating mass compensating for the non-uniform distribution of the signal transmitter mass.

15. Rotor according to claim 14, wherein the rotor is balanced.

16. Rotor according to claim 14, wherein the signal transmitter mass is made of a substantially soft magnetic material and the compensating mass is made of a substantially non-magnetic material.

17. Rotor according to claim 14, wherein the signal transmitter mass and the compensating mass are joined together, forming the rotor, via a connecting face which is inclined in relation to the longitudinal axis of the rotor.

18. Rotor according to claim 14, wherein the connecting face is a connecting plane extending at an acute angle to the longitudinal axis.

19. Rotor according to claim 14, wherein the signal transmitter mass and the compensating mass supplement each other to form the rotor with a circular cylindrical surface, the axis of symmetry of which coincides with the longitudinal axis.

20. Reluctance resolver for converting a rotational value of a shaft, such as an angular position or an angular acceleration, into an electrical signal, with a stator comprising at least one magnetic field generator which in operation generates a magnetic field and at least one magnetic field sensor which converts the magnetic field into an electrical signal, and with a rotor which is arranged in the interior of the stator and comprises a signal transmitter mass which can be used to change the magnetic field in the region of the magnetic field sensor as a function of the rotational value, wherein the rotor is embodied in accordance with claim 14.

21. Reluctance resolver according to claim 20, wherein the rotor and the stator are at a constant minimum distance from each other in the radial direction along the longitudinal axis and an outer annular gap, extending along the longitudinal axis, remains between the rotor and the stator.

22. Reluctance resolver according to claim 20, wherein a separating element, which separates a volume arranged around the rotor from the stator, is arranged in the outer annular gap.

23. Reluctance resolver according to claim 22, wherein the separating element is produced as a foil separating the stator from the rotor in a fluid-tight manner or a metal sheet made of a non-corroding material.

24. Reluctance resolver according to claim 22, wherein the separating element is designed in a cap-shaped manner and, placed over the cylindrical rotor, connected to the stator in a pressure-tight manner.

25. Reluctance resolver according to claim 20, wherein the stator comprises at least two magnetic field sensors which are arranged offset by an angle about the longitudinal axis.

26. Reluctance resolver according to claim 22, wherein, during operation of the reluctance resolver, the volume between the separating element and the rotor is filled with pressurized hydraulic oil.
